(19) United States
(12) Patent Application Publication
(10) Pub. No.: US 2007/0090648 A1
(43) Pub. Date: Apr. 26, 2007

(54) Energy Generation Device

(76) Inventor: Michael C. Barksdale, San Marcos, CA (US)

Correspondence Address: Rutan & Tucker, LLP;Robert D. Fish, 611 ANTON BLVD, SUITE 1400, COSTA MESA, CA, 92626, US

(21) Appl. No.: 11/552,661

(22) Filed: Oct. 25, 2006

Related U.S. Application Data
(60) Provisional application No. 60/730,505, filed on Oct. 26, 2005.

(51) Int. Cl. H02K 7/18; F03G 7/08; F02B 63/04

(52) U.S. Cl. 290/1 R

(57) ABSTRACT

A machine containing many moveable parts that outputs more energy than it takes to make it operate is provided. In operation, a plurality of heavy, preferably metal, balls are arranged to roll from a first location on a level platform down an inclined tube to a first stop gate located below the platform. A large drive wheel, centered on a horizontal shaft and arranged normal thereto, is adapted to rotate in a vertical plane and comprises a plurality of arms extending radially outward from a rotatable center. Each arm includes a channel or ball-supporting surface extending from between the wheel center and the end of the arm. The balls are introduced, through the first stop, to the channel of each arm when the arm passes downward, through the horizon, and are arranged to move in plurality to the end of the arm for resting on the ball-supporting surface. The weight of the balls on the arm force the arm to rotate downward, about the center of the wheel, thereby giving the wheel its driving force to rotate about its center. As the arms reach their lowest point in rotation, they are freed from the arm and directed to an elevator, driven by the wheel, and are raised upward to the platform in preparation of their journey onto the arms of the wheel.

### CROSS-REFERENCE TO RELATED APPLICATIONS

This application claims priority to the earlier filed U.S. Provisional Patent application having a Ser. No. 60/730,505 and filed on Oct. 26, 2005.

### BACKGROUND OF THE INVENTION

1. Technical Background

This invention pertains to the field of perpetual motion machines. These are machines that require less energy to run that is outputted by the machine. In this case, the invention is a machine that produces torque at an output shaft that may be connected to an electric generator to produce electrical energy for use by others in quantities that are in excess of the energy required to operate the machine.

2. Description of Related Art

Throughout history there have been many attempts to develop energy producing machines that utilize very little to no energy in the creation of new energy sources. Most of these attempts have met with failure.

The history of free energy machines dates back for centuries wherein inventors looked for ways of producing large quantities of energy without the need to insert equally large quantities of energy to output that result. It has not been clear whether such devices were even possible, but the development of modem thermodynamics may have led most engineers and scientists to agree that machines that produce perpetual energy without the need for energy insertion is impossible. Many inventors, scientists and engineers have tried to construct a device that uses perpetual motion to create energy, but have been largely unsuccessful. Proponents of perpetual motion devices often use terms to describe their invention including free energy device, mechanisms and/or formulas and over unity machines.

Perpetual motion devices are usually described as devices that produce energy out of nothing. (i.e., no energy use to produce energy) Over time, many scientists have tried to use not only energy creating machines but methods of exploiting non-obvious power sources, methods and techniques and devices with very little energy loss and/or devices that take very limited amount of energy input to run the devices. For instance, using the forces of nature, one can harness the energy of churning water or water falls, water currents and the like. The harnessing of this energy from naturally occurring phenomenon costs very little in the way of energy input yet yields significant energy output. Many a scientist and/or engineer has tried to duplicate these results using other types of technology and low input energy sources. The attempts have been along the lines of pure science, applied science, and sheer folly and fraud.

However, a need still exists for a machine and/or device that may generate significant amounts of energy without the use of significant energy to run the machine and/or device. The present invention is believed to be one of the first instances of sheer success in the applied science area and is a serous contender for being one of the first, if not the first, machine that produces more energy than it takes to run it.

### BRIEF SUMMARY OF THE INVENTION

This invention pertains to a machine containing many moveable parts that outputs more energy than it takes to make it operate. In operation, a plurality of heavy, preferably metal, balls are arranged to roll from a first location on a level platform down an inclined tube to a first stop gate located below the platform. A large drive wheel, centered on a horizontal shaft and arranged normal thereto, is adapted to rotate in a vertical plane and comprises a plurality of arms extending radially outward from a rotatable center Each arm includes a channel or ball-supporting surface extending from between the wheel center and the end of the arm. The balls are introduced, through the first stop, to the channel of each arm when the arm passes downward, through the horizon, and are arranged to move in plurality to the end of the arm for resting on the ball-supporting surface. The weight of the balls on the arm force the arm to rotate downward, about the center of the wheel, thereby giving the wheel its driving force to rotate about its center. As the arms reach their lowest point in rotation, they are freed from the arm and directed to an elevator powered by a small AC motor, driven by the wheel, and are raised upward to the platform in preparation of their journey onto the arms of the wheel.

To this end in an exemplary embodiment of the present invention an energy generation device is disclosed. The device has a plurality of heavy cylindrical spheres ad an included tube having a first stop gate located on a level platform. Moreover, the energy generation device has a drive wheel centered on a horizontal shaft adaptable to be rotated in vertical plane and a plurality of arms extending radially outward from a rotatable center of the drive wheel.

In an exemplary embodiment, the energy generation device has heavy cylindrical spheres that are made of metal.

In an exemplary embodiment, the energy generation device has heavy cylindrical spheres that are arranged to roll from a first location on the level platform down an included tube to the first stop gate located below the platform

In an exemplary embodiment, the energy generation device has a plurality of arms having a channel surface extending from between the wheel center and the end of the arm.

In an exemplary embodiment, the energy generation device has a plurality of arms including a ball supporting surface extending from between the wheel center and the end of the arm.

In an exemplary embodiment, the energy generation device has an elevator system to elevate the heavy cylindrical spheres from a position at the bottom of the device to the platform.

In an exemplar embodiment, the energy generation device has continual movement of the plurality of arms that creates storable energy wherein said energy is stored in a storage means.

In an exemplary embodiment, the energy generation device has a level platform having a first portion and a second portion wherein the second portion is in direct communication with at least a single of the plurality of arms.

In an exemplary embodiment, the energy generation device has a wheel being rotated about its center causing the rotation and expulsion of the plurality of heavy cylindrical spheres.

To this end, in an exemplary embodiment of the present invention, a method of using an energy generation device, the method comprising the steps of: providing a plurality of heavy cylindrical spheres; a included tube having a first stop gate located on a level platform; a drive wheel centered on a horizontal shaft adaptable to be rotated in vertical plane; and a plurality of arms extending radially outward from a rotatable center of the drive wheel.

In an exemplary embodiment, the method comprises the further step of having heavy cylindrical spheres that are arranged to roll from a first location on the level platform down a tube to a first stop gate below the platform.

In an exemplary embodiment, the method comprises the further step of: providing a plurality of arms that includes a channel surface extending from between the wheel center and the end of the arm.

In an exemplary embodiment, the method comprises the further step of: said plurality of arms include a ball supporting surface extending from between the wheel center and the end of an arm.

In an exemplary embodiment, the method comprises the further step of providing an elevator system to elevate the heavy cylindrical spheres from a position at the bottom of the device to the platform.

In an exemplary embodiment, the method comprises the further step of: placing said heavy cylindrical spheres in cue for insertion into at least one of said plurality of arms for rotation about the drive wheel.

In an exemplary embodiment, the method comprises the further step of: influencing said heavy cylindrical sphere by gravity thereby forcing the arms to rotate about the drive wheel.

In an exemplary embodiment, the method comprises the further step of: positioning near the bottom of the drive wheel such that the heavy cylindrical spheres are expelled from the arm of the drive wheel

In an exemplary embodiment, the method comprises the further step of: inserting said plurality of heavy cylindrical spheres into said plurality of arms extending radially outward from the rotatable center of the drive wheel.

In an exemplary embodiment, the method comprises the further step of: providing a storage means for storage of the generated energy produced by the device.

In an exemplary embodiment, the method comprises the further step of: providing a transportation means between the energy generation device and the storage means.

It is therefore an object of the present invention to provide an energy generation device that produces energy without excessive need for energy input to run the device.

Yet another object of the present invention is to provide an energy generation device that produces far more energy than it takes to run the device.

Still another object of the present invention is to provide an energy generation device that is efficient to run and takes very little maintenance and/or outside intervention.

Another object of the present invention is to provide an energy generation device that utilizes the forces of gravity to create and capture energy.

Still another object of the present invention is to provide an energy generation device that utilizes a plurality of weighted spheres to produce downward force on the device to rotate the device thereby creating continual motion that may be captured and stored as usable energy.

Yet another object of the present invention is to provide an energy generation device that may utilize a wheel structure that may be rotatable about a central axis whereby the continue rotation of the wheel about the central axis may create useable energy.

Still another object of the present invention is to provide an energy generation device that may utilize a storage means that may store transferred power from the device at a location proximate to the device.

Another object of the present invention is to provide an energy generation device that may utilize a transfer means that may transfer power from the device from the device to the storage means wherein the transfer means may be simple electrical wiring.

An additional object of the present invention is to provide an energy generation device wherein the device may have an elevator system whereby the elevator system may elevate the weighted spheres from a location at the base of the device to a position at the top of the device.

Still another object of the present invention is to provide an energy generation device wherein the device may have a plurality of arms wherein the arms may have a channel and/or groove located thereon for channeling the weighed spheres from a first location on the arms to a second location on the arms.

Yet another object of the present invention is to provide an energy generation device wherein the device may have a plurality of arms thereon wherein the arms may have a stop gate located thereon to allow displacement of the weighted spheres only at a certain point in the rotation of the arms about the central axis of the device.

Another object of the invention is to provide an energy generation device wherein the device may utilize a plurality of arms and a plurality of weighted spheres to keep the device in continual operation.

In yet another exemplary embodiment of the present invention, an energy generation device may be provided that has an unloading mechanism for unloading of the weighted spheres from the arm.

In yet another exemplary embodiment of the present invention, and energy generation device may be provided that may have a platform system whereby a plurality of weighted spheres may be position on the platform system in ready state for loading onto the arms of the energy generation device.

Still another exemplary embodiment of the present invention is an energy generation device wherein the device may have a large drive wheel having arms that extend radially outward from a common center.

In yet another exemplary embodiment of the present invention, an energy generation device may be provided wherein the device may have a ball release mechanism which allows for discharge of the weighted spheres from the arm mechanism at a position of the arm about the central drive wheel.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### DESCRIPTION OF THE DRAWINGS

FIG. 1 is a side elevational view of the large drive wheel of the invention showing the arms extending radially outward from a common center;

FIG. 2 is a side view of the invention in an exemplary embodiment of the present invention;

FIG. 3 is a top view of the device in an exemplary embodiment of the present invention; and

FIG. 4 is a bottom view of the device in an exemplary embodiment of the present invention.

### DETAILED DESCRIPTION OF THE INVENTION

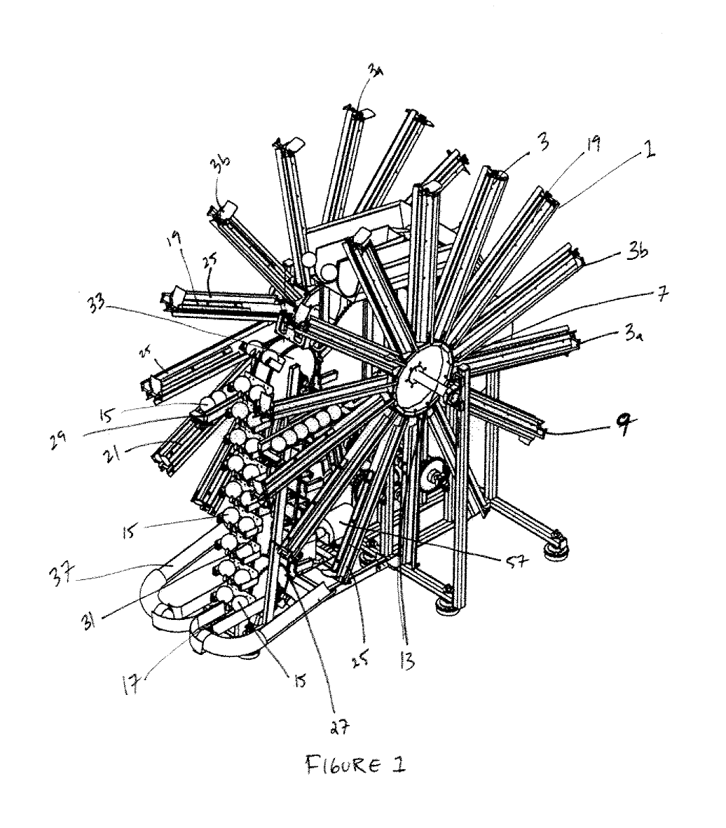

Turning now to the drawings, where like numbers identify like elements throughout the twelve figures, FIG. 1 shows a large drive wheel 1 comprising at least one set, but preferably two, spaced-apart sets of arms 3a and 3b equidistantly spaced about a wheel center 5 and mutually spaced-apart and normal to the axis of a drive shaft (not shown) passing through the centers of both sets of arms 3a and 3b.

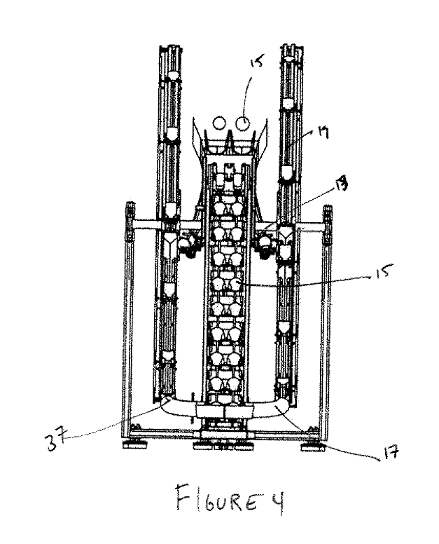

Each arm of sets 3a and 3b includes a first end 7, connecting said respective arm to said drive shaft, a second end 9 located at the far end of said arm and further containing a direction turn device 13 for turning the course of a heavy ball 15, such as a metal ball, passing along arm 3, to a different direction. As shown in FIGS. 1, 5, 7 and 12, said direction turn device 13 is in the form of a 90° elbow. In addition, a gate 17 is mounted on the outlet side of device 13 to control passage of balls 15 there through. A channel 19 is shown in FIGS. 1 and 4 comprising a channel floor 21, on which to support balls 15 in rolling motion, and opposed, spaced-apart, upstanding channel side walls 25 for preventing balls 15 from falling off or out of channels 17 during travel of arms 3 about drive wheel 1.

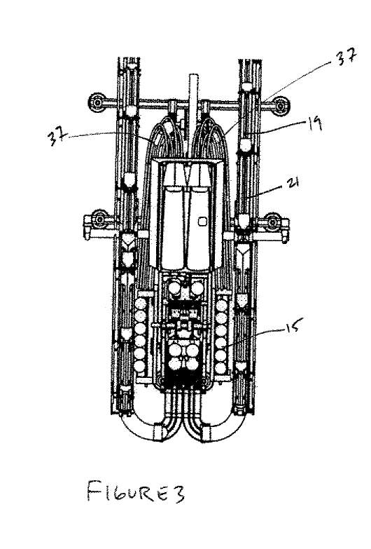

As shown in FIGS. 3, 4, 6 and 11, an elevator 27 is provided to accept the balls 15 from gate 17 and arrange them in pairs, one from each of radial sets of arms 3a and 3b, and carry them upward, from their disgorgement area to a platform 29 where balls 15 are deposited and await further introduction into channels 19 of arms 3a and 3b for further processing in drive wheel 1.

Elevator 27 is comprised of a plurality of saddles 31 that are held in a fixed orbit to traverse a position below said lower area of second arm end 9, and receive balls 15 therein and traverse upward, under power from a chain drive 33, powered by the rotational energy obtained from drive wheel 1, to a position adjacent platform 29 whereupon said balls 15 are released from saddles 31 and begin their traverse downward from platform 29, through a series of conduits 37 to a first stop 39 wherein they await registation with first 7 of arms 3a and/or 3b. Upon registration, said stop is triggered to release said balls to travel from said platform 29 onto said channels 19 for processing as aforesaid.

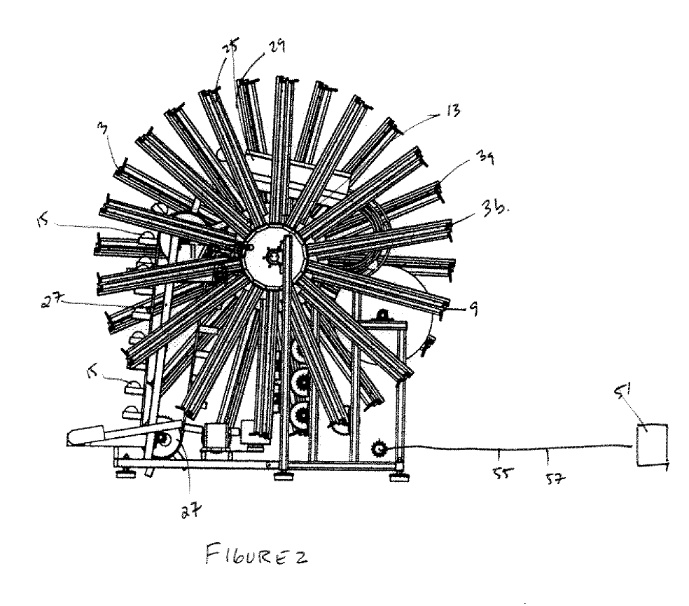

FIG. 2 illustrates the plurality of balls 15 passing along a trough 43 from platform 29 to the introduction point on the wheel into channel 19. FIG. 5 illustrates the drive mechanism for elevator 27. FIGS. 8 and 9 illustrate balls 15 awaiting introduction into arm channels 19 for processing and driving wheel 1 in a clockwise motion about center 5. FIG. 10 illustrates arms 3 as they exit the transfer area wherein the plurality of balls 15 are removed from the arms 3 and transferred to elevator 27 wherein the elevator 27 elevates the plurality of balls 15 to the platform 29 for insertion into the arms 3. This process may be continually repeated wherein the repeated process and the rotation of the large drive wheel 1 causes the creation of energy. This energy is generated by continued rotation of the large drive wheel 1 and is transferred from the large drive wheel 1 to a storage means 51 located at a location proximate to the large wheel 1. The energy may be transferred by a transfer means 55 which in an exemplary embodiment of the present invention may be a electrical wire 57. The electrical wire may transfer energy created during repeated rotation of the large wheel 1 from the wheel 1 to the storage means 51, whereby the storage means 51 may transfer energy to another location and/or may store the energy in the same manner as a battery.

The above-described device may be altered by means known in the art without departing from the spirit and scope of this invention.

Thus, specific embodiments and applications of a safety device system have been disclosed. It should be apparent, however, to those skilled in the art that many more modifications besides those already described are possible without departing from the inventive concepts herein.

The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An energy generation device comprising:
a plurality of heavy cylindrical spheres;
a included tube having a first stop gate located on a level platform;
a drive wheel centered on a horizontal shaft adaptable to be rotated in vertical plane; and
a plurality of arms extending radially outward from a rotatable center of the drive wheel.

2. The energy generation device of claim 1, wherein the heavy cylindrical spheres are made of metal.

3. The energy generation device of claim 1 wherein a heavy cylindrical spheres are arranged to roll from a first location on the level platform down an included tube to the first stop gate located below the platform.

4. The energy generation device of claim 1 wherein the plurality of arms includes a channel surface extending from between the wheel center and the end of the arm.

5. The energy generation device of claim 1 further comprising:
said plurality of arms including a ball supporting surface extending from between the wheel center and the end of the arm.

6. The energy generation device of claim 1 further comprising:
an elevator system to elevate the heavy cylindrical spheres from a position at the bottom of the device to the platform.

7. The energy generation device of claim 1 where in the continual movement of the plurality of arms creates storable energy wherein said energy is stored in a storage means.

8. The energy generation device of claim 1 further comprising:
said level platform having a first potion and a second portion wherein the second portion is in direct communication with at least a single of the plurality of arms.

9. The energy generation device of claim 1 further comprising:
the wheel being rotated about its center causing the rotation and expulsion of the plurality of heavy cylindrical spheres.

10. A method of using an energy generation device, the method comprising the steps of:
providing a plurality of heavy cylindrical spheres;
a included tube having a first stop gate located on a level platform;
a drive wheel centered on a horizontal shaft adaptable to be rotated in vertical plane; and
a plurality of arms extending radially outward from a rotatable center of the drive wheel.

11. The method as described in claim 10 further comprising:
heavy cylindrical spheres that are arranged to roll from a first location on the level platform down a tube to a first stop gate below the platform.

12. The method as described in claim 10 further comprising:
providing a plurality of arms that includes a channel surface extending from between the wheel center and the end of the arm.

13. The method as described in claim 10 wherein said plurality of arms include a ball supporting surface extending from between the wheel center and the end of an arm.

14. The method as described in claim 10 further comprising:
providing an elevator system to elevate the heavy cylindrical spheres from a position at the bottom of the device to the platform.

15. The method as described in claim 10 wherein said heavy cylindrical spheres are placed in cue for insertion into at least one of said plurality of arms for rotation about the drive wheel.

16. The method as described in claim 10 wherein said heavy cylindrical sphere are influenced by gravity thereby forcing the arms to rotate about the drive wheel.

17. The method as described in claim 10 wherein at a position near the bottom of the drive wheel, said heavy cylindrical spheres are expelled from the arm of the drive wheel

18. The method as described in claim 10 wherein said plurality of heavy cylindrical spheres are insertable into said plurality of arms extending radially outward from the rotatable center of the drive wheel.

19. The method as described in claim 10 further comprising:
providing a storage means for storage of the generated energy produced by the device.

20. The method as described in claim 10 further comprising:
providing a transportation means between the energy generation device and the storage means.
